(19) United States
(12) Patent Application Publication
(10) Pub. No.: US 2005/0151037 A1
(43) Pub. Date: Jul. 14, 2005

(54) Self-stabilising support

(76) Inventor: Nicholas A Oxley, New York, NY (US)

Correspondence Address: BACHMAN & LAPOINTE, P.C., 900 CHAPEL STREET, SUITE 1201, NEW HAVEN, CT, 06510, US

(21) Appl. No.: 10/505,306

(22) PCT Filed: Feb. 21, 2003
(86) PCT No.: PCT/GB03/00753

(30) Foreign Application Priority Data
Feb. 21, 2002 (GB) 0204075.6
Jun. 25, 2002 (GB) 0214657.9

(51) Int. Cl. F16M 11/24

(52) U.S. Cl. 248/188.3

(57) ABSTRACT

A self-stabilising support for a structure, e.g. a chair, is disclosed, which comprises: a first pair of legs (1), means connected to the first pair of legs for supporting the structure, e.g. the upper part of the chair (3); a second pair of legs (2); a bearing acting between the first pair of legs (1) and the second pair of legs (2) and allowing the second pair of legs to pivot with respect to the first pair of legs about an axis whereby the four legs of the first and second pair can, by suitably pivoting the second pair of legs with respect to the first pair, be firmly planted on an uneven surface to support the said structure. The bearing is damped so that it does resist sudden movement between the first and the second legs about the bearing but a sustained force causes pivoting movement of the second pair of legs about the bearing.

### TECHNICAL FIELD

The present invention relates to a support for use in providing stable support for structures, even on an uneven horizontal surface. It is particularly applicable to provide support for furniture, such as chairs, tables, beds, benches, chests of drawers, shelving units and pedestals, e.g. supports for electronic or scientific equipment such as televisions and monitors, but also can be applied in any other field where a stable support is required.

### BACKGROUND ART

When furniture supported on four legs is placed on an uneven floor, all four legs do not necessarily engage the floor and if not the furniture can wobble i.e. it is prone to unwanted and often disturbing rocking motion.

Although three legged supports are not prone to rocking, they are inherently less stable than four legged supports and can more easily be toppled over, especially when the centre of gravity of the supported structure is not located towards the middle of the three legged support.

FR-1537888 describes a table having a top supported by a pair of supports that are joined below the table by a bar, a cross member is provided at each end of the bar, each cross member having a pair of feet. One of the cross members is rigidly fixed at one end of the bar and the second cross member is pivotable about an axis that is coaxial with the bar; on uneven ground, the second cross member can pivot so that all four legs are on the ground. Since, the second cross member is freely pivotable, it provides comparatively little additional stability as compared to a three-legged support.

U.S. Pat. No. 2,793,468 describes table similar to that described in FR-1537888 but the pivotable cross member is fixed in position once all four feet have engaged the ground. Although such an arrangement is more stable than that of FR-1537888, the table has to be readjusted each time it is moved to a different site, which is time consuming and awkward.

EP-A-0008054 describes a bench having a bench having a top supported by a pair of vertical supports that each has at its lower end a cross member. The cross members each have a pair of feet. The supports are joined by a stretcher bar that can be locked in position.

EP-A-0006230 describes a table having four legs arranged in pairs. The legs are tubular and feet are extendable telescopically from within the tubular legs to ensure that the table sits evenly on an irregular floor.

SE-511494 describes the base of a piece of furniture having front and rear pairs of legs and an articulated joint between the two leg pairs for ensuring that the legs remain in contact with the floor.

The present invention provides a support having four legs that can automatically adjust themselves so that they all engage the surface on which they are standing even when that surface is uneven but in which the four legs provide additional stability.

### DISCLOSURE OF THE INVENTION

According to the present invention, there is provided a self-stabilising support comprising a first pair of legs, means connected to the first pair of legs for supporting a structure and a second pair of legs pivotable with respect to the first pair of legs about an axis whereby the four legs of the first and second pair can, by suitably pivoting the second pair of legs with respect to the first pair, be firmly planted, even on an uneven surface, such as a floor, to support the said structure.

According to the second aspect of the present invention, there is provided an article of furniture supported on legs, the legs being formed by the support as defined above.

The axis about which the second pair of legs rotates cannot be vertical and is preferably generally horizontal in use. Rotation about a horizontal axis minimises the alteration in the position of the structure if the second pair of legs are rotated out of exact alignment with the first pair of legs. Rotation about an axis having horizontal and vertical components is possible but less preferred. The axis preferably extends perpendicular to a line (or more strictly a projection of a line) joining the feet of the first pair of legs (the “feet” being the ends of the legs that engage the ground.)

It is preferred that the only substantial relative motion between the first and second pairs of legs is rotation about the axis since otherwise the support structure will not be rigid.

The pivoting motion of the second pair of legs is preferably achieved by a bearing assembly, for example an axle secured to one of the pairs of legs and a sleeve bearing attached to the other pair of legs and rotatable on the said axle. However other types of bearing are useable in the present invention.

### BRIEF DESCRIPTION OF DRAWINGS

A chair according to the present invention will now be described, by way of example only, with reference to the accompanying drawings in which:

FIG. 1 is the side view of the chair;

FIG. 2 is a rear view of the chair;

FIG. 3 is a view looking up at the bottom of the chair;

FIG. 4 is a detailed view showing the connection between the front and rear legs of the chair shown in FIGS. 1 to 3; and

FIG. 5 is a rear view of the chair similar to FIG. 2 but shows the chair legs pivoted with respect to each other to enable it to stand on uneven ground;

FIG. 6 is a detailed sectional view of a damping device for use with the chair of FIGS. 1 to 5;

FIG. 7 is a second embodiment of a bearing between the front and the back legs of the chair of FIGS. 1 to 5;

FIG. 7a is sectional view through line a-a of FIG. 7;

FIG. 8 is a third embodiment of a bearing between the front and the back legs of the chair of FIGS. 1 to 5; and

FIGS. 8a and b are sectional views through lines a-a and b-b of FIG. 8, respectively.

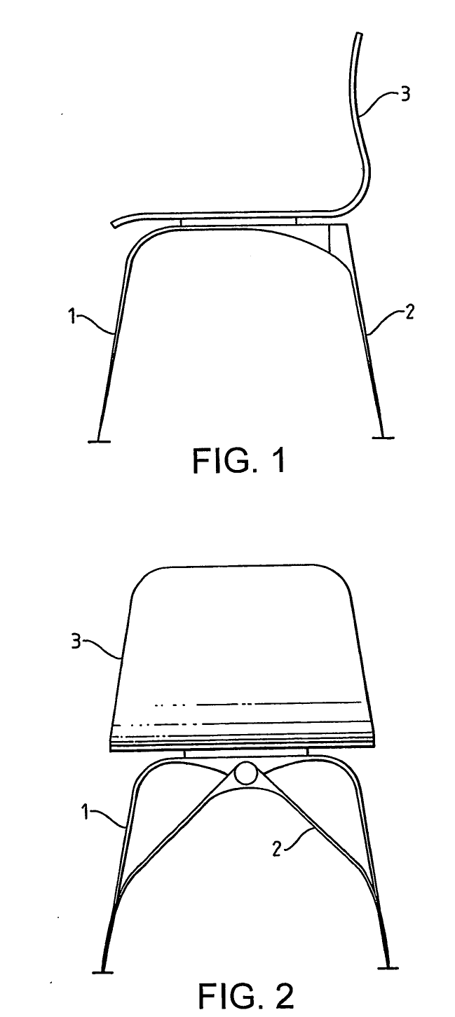

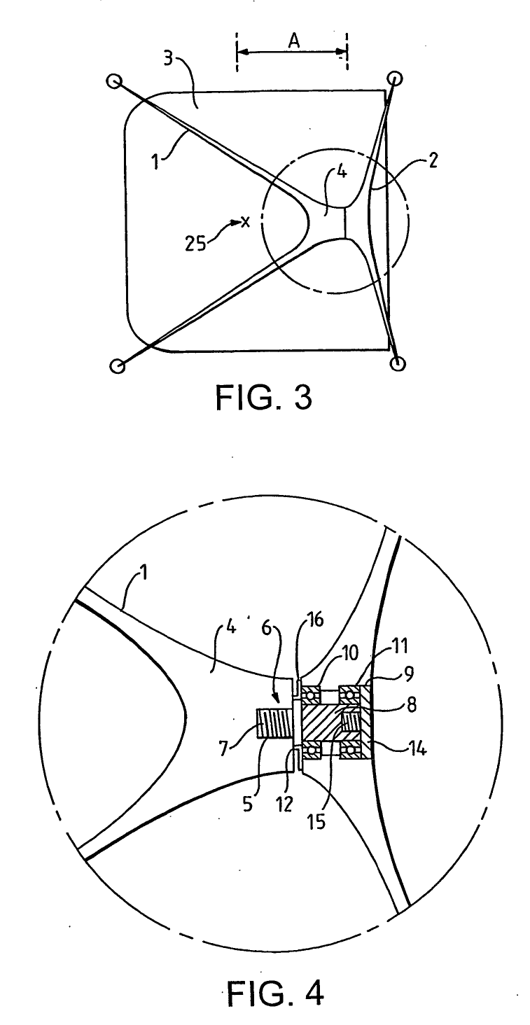

### BEST MODE FOR CARRYING OUT THE INVENTION

The chair depicted in the accompanying drawings includes a pair of front legs 1, a rear pair of legs 2 and a seat 3. The seat 3 is fixed to the front legs by bolts (not shown) passing through the seat and engaging in threaded holes (not shown) in the front legs. It is important that the seat is not rigidly supported by the second pair of legs since otherwise the pivoting motion of the two pairs of legs described below cannot take place. In this instance, the seat 3 is not directly connected to the rear set of legs at all.

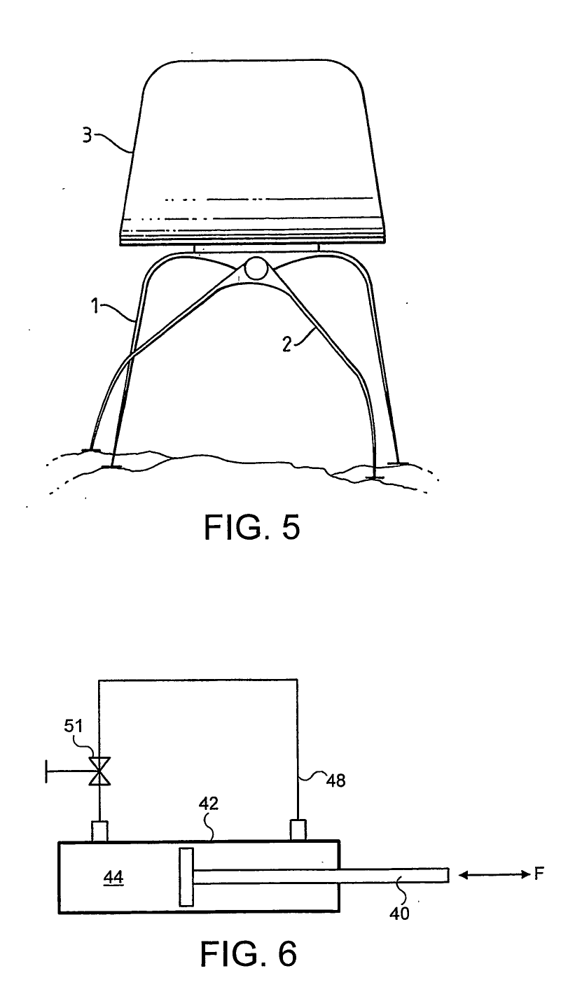

The rear set of legs is pivotally attached to the front set of legs by a bearing X (see FIG. 5) shown in detail in FIG. 4. In FIG. 4, front legs include an internally threaded bore 5 in the region 4 where the front legs converge. A threaded portion 7 of a threaded axle 6 is screwed into, and hence firmly engaged in, the threaded bore 5. The threaded axle 6 also includes a smooth cylindrical axle portion 8, which projects rearwardly from the front legs 2, and a shoulder 12 between the threaded portion 7 and the cylindrical axle portion 8. The shoulder abuts the front legs (i.e. comes to a hard stop) when the threaded portion 7 has been fully screwed into the bore 5.

The rear pair of legs 2 includes a bore 9 having a pair of ball bearings 10, 11 secured by their outer race to the wall of the bore 9. The axle portion 8 extends through the bore 9 and engages the inner races of the ball bearings 10,11; the bearings 10, 11 allow the rear legs 2 to pivot about the axle 8. An end cap 14 is secured by means of a screw thread 15 in the end of the axle 8 and sits in the bore 9 engaging the inner race of the ball bearing 11 and closing off one end of the bore 9 and retaining the axle 8 within the bore.

A wave spring 16 is located between the shoulder 12 and the inner race of ball bearings 10 and provides an axial force to constrain the axial motion between the first and second legs.

As is evident from FIG. 4, the rear legs can pivot about axle 8 with respect to the front set of legs 1. Preferably, only limited rotation of the rear legs is permissible and stops (not shown) are included to limit the relative rotation. The preferred arc of rotation is less than 20°, e.g. 5°-10°. This allows the rear legs to adjust to unevenness in the floor on which the chair is placed so that all four legs are firmly set on the floor. This is shown in FIG. 5, where the front legs are supported on contour 21 of an uneven surface and rear legs are supported on a different contour 22 as a result of the rear legs 2 pivoting about an axis.

Although the seat 3 is not directly connected to the rear set of legs 2 at all in the embodiment described above, it is possible for the rear legs also to support the seat if such support allows the pivoting movement described above. This will generally be possible if the connection between the seat and the rear legs is a bearing about an axis co-linear with the axis of the axle 8.

The stability of the chair is increased if its centre of gravity 25 is spaced apart from the axle 8 preferably by a horizontal distance A greater than a threshold; this threshold value depends on the particular geometry of the chair. The larger the distance, the greater is the stability of the chair but obviously other considerations must also be taken into account, e.g. the user requirement dictating the overall size and design of the chair.

The bearing between the front and back legs 1, 2 is damped, that is to say motion between the two sets of legs takes place gradually, slowly and smoothly. A damped bearing assembly will provide resistance to sudden forces but will yield to a continuous force. A damped bearing will benefit the design in several ways. Firstly, the support structure for the seat 3 will adjust automatically to suit the surface that it is placed on, although this will happen slowly and gently as opposed to quickly and suddenly, as would happen in the case of an undamped bearing. In the presence of any sudden force acting in a way to move, topple or disrupt the support structure for the seat, the two sets of legs 1, 2 will behave over a short duration as if they were rigidly attached to one another, as a result of the damping. Damping will have an influence on the feel of the chair or other seat or superstructure incorporating the support structure of the present invention. The support structure will not generally require any manual adjustment or fixing in order to operate in the described manner.

FIG. 6 shows one example of how damping may be accomplished. FIG. 6 shows a cylinder 42 divided into two chambers by a piston 40 that can move axially along the cylinder. The two chambers 44 and 46 are filled with a fluid, preferably a liquid such as an oil, and are in fluid communication with each other via a line 48 containing a flow control valve 51 that can be adjusted to provide the degree of damping required. The openings 50 and 52 from chamber 44 and 46 provides substantially less restriction to flow into and out of chambers 44 and 46, as compared to that provided by flow control valve 51. The piston and cylinder 40, 42 act between, on the one hand, the rear legs 2 and, on the other hand, any other part of the rest of the chair, e.g. the front legs 1, the region 4 where the front legs converge or even (although this is not preferred) the seat 3. When a force F is applied to extend or contract the piston-cylinder arrangement, the flow control valve 51 opposes the force by restricting the flow of fluid into and out of chambers 44 and 46, thereby damping the movement of the rear legs 2.

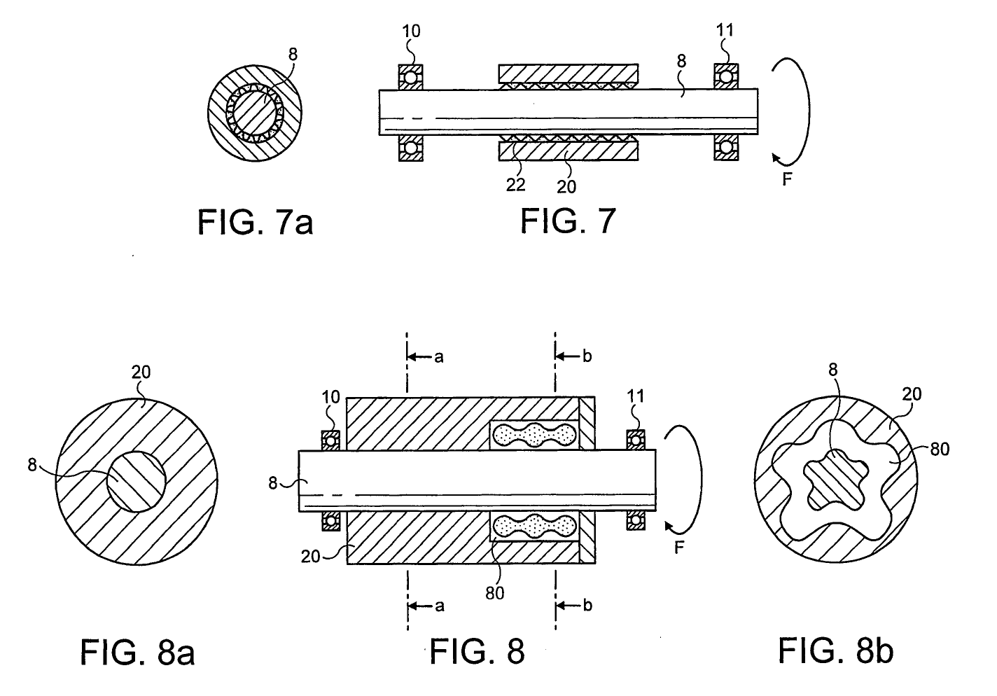

FIG. 7 shows a second example of a damping arrangement. This arrangement is similar to that shown in FIG. 4, where the shaft 8 is secured to the region 4 of the front legs, e.g. by a screw thread 5 (see FIG. 4). The rear legs 2 are supported on the shaft via bearings 10, 11 and a bushing 20. A layer 22 of a viscous fluid, e.g. thick silicon gel, is provided between the shaft 8 and the bushing 20. The thick silicon gel will prevent the bushing 20 rotating easily on the shaft 8 and so will provide damping resistance to an applied force F tending to rotate the rear legs 2 relative to the front legs 1. The viscous fluid may be a dilitant composition, i.e. a composition that acts like a solid and retains its shape when subjected to a sudden pressure but yields when subjected to a slowly applied pressure. Alternatively, the fluid may be thixotropic, i.e. it acts like a solid gel with high viscosity until a shear force is applied to it that exceeds a threshold value, whereupon its viscosity drops and it readily flows. Suitable materials are silicon gels, silicone polymers and viscous colloids such as putties, e.g. Silly Putty™, which is manufactured by Binney & Smith of Easton, Pa., USA.

Instead of having cylindrical walls, the shaft 8 and bushing 20 may be profiled, as can be seen from FIGS. 8 and 8b, to provide a profiled cavity 80 containing the viscous fluid so that the fluid is subjected to substantial shear forces before the shaft 8 can turn. The rheology of the fluid should be chosen such that it will allow the shaft to turn when a threshold force F is applied to rotate the shaft over a desired time, e.g. of the order of seconds.

The damping arrangement will generally introduce a measure of resilience when it initially resists movement of the rear legs but the damping action should not be provided solely by a spring or other resilient arrangement but rather, as described above, by an arrangement that allows displacement between the front and the rear legs after an initial resistance but once the displacement has occurred, does not act to restore the legs fully to their initial position.

Many other alternative designs are of bearing and damping are of course possible and the present application is not limited to the particular bearing shown and described.

1. A self-stabilising support for a structure comprising:
a first pair of legs,
means connected to the first pair of legs for supporting the structure;
a second pair of legs;
a bearing acting between the first pair of legs and the second pair of legs and allowing the second pair of legs to pivot with respect to the first pair of legs about an axis whereby the four legs of the first and second pair can, by suitably pivoting the second pair of legs with respect to the first pair, be firmly planted on an uneven surface to support the structure; and
damping means to dampen and resist pivoting movement of the second pair of legs about the bearing.

2. A support as claimed in claim 1 wherein, in use, the axis lies in a generally horizontal plane.

3. A support as claimed in claim 1 wherein the axis extends generally perpendicularly to a notional line joining the ends of the legs of the first pair that engage the ground.

4. A support as claimed in claim 1 wherein the only substantial relative motion between the first and second pairs of legs is the said pivoting about the axis.

5. A support as claimed in claim 1 wherein the damping means comprises a piston and cylinder acting directly or indirectly between the first and second pair of legs and acting to resist pivoting movement of the second pair of legs about the bearing.

6. A support as claimed in claim 1 wherein the damping means comprises a body of viscous fluid arranged to be displaced by a pivoting movement of the second pair of legs about the bearing.

7. A support as claimed in claim 6, wherein the viscous fluid comprises a gel, a colloid, a dilitant composition or a thixotropic composition.

8. A support as claimed in claim 6 wherein the viscous fluid is selected from the group consisting of silicon gels, silicone polymers and viscous colloids.

9. A support as claimed in claim 6 wherein the bearing comprises said body of viscous fluid.

10. A support as claimed in claim 9, wherein the bearing comprises a shaft, a bushing and a chamber between the shaft and the bushing in which said body of viscous fluid is accommodated.

11. A support as claimed in claim 10, wherein the chamber is defined at least in part by a wall formed by the shaft and a wall formed by the bushing and wherein at least one of the said walls is not circular cylindrical in shape.

12. An article of furniture supported on legs, the legs being formed by the support as defined in claim 1.

13. An article of furniture as claimed in claim 12, wherein a center of gravity of the article is spaced apart in a horizontal direction from the axis.

14. An article of furniture as claimed in claim 12 being a chair having a seat and a back.

15. An article of furniture supported on legs, the legs being formed by the support as defined in claim 10.

16. An article of furniture as claimed in claim 15 being a chair having a seat and a back.

17. An apparatus comprising:
a first member for engaging an uneven support surface;
a second member for engaging the uneven support surface;
a structure supported above the uneven support surface;
a bearing acting between the first member and the second member and allowing the member to pivot with respect to the first member about an axis so that the first and second members can, by pivoting the second member with respect to the first member, be firmly planted on the uneven support surface to support the structure; and
a damper coupled to resist pivoting movement of the second member about the axis.

18. The apparatus of claim 17 wherein:
the first member comprises a first pair of legs; and
the second member comprises a second pair of legs.

19. The apparatus of claim 18 wherein:
there are no legs other than said first and second pairs of legs.

20. An apparatus comprising:
a first means for engaging an uneven support surface;
a second means for engaging the uneven support surface;
a structure supported above the uneven support surface;
a bearing and damping means acting between the first means and the second means for allowing the second means to pivot in a damped manner with respect to the first means, so that the first and second means can, by pivoting the second means with respect to the first means, be firmly planted on the uneven support surface to support the structure.
